(19) United States
(12) Patent Application Publication
(10) Pub. No.: US 2014/0124459 A1
(43) Pub. Date: May 8, 2014

(54) NO FILTER NO RUN FEATURE FOR FILTER

(71) Applicants: Hanhao Li, Beijing (CN); Ping Shen, Shanghai (CN); Penghua Hou, Shanghai (CN); Chunxi Wang, Wuhan Hubei (CN)

(72) Inventors: Hanhao Li, Beijing (CN); Ping Shen, Shanghai (CN); Penghua Hou, Shanghai (CN); Chunxi Wang, Wuhan Hubei (CN)

(73) Assignee: CUMMINS FILTRATION IP INC., Minneapolis, MN (US)

(21) Appl. No.: 14/112,615

(22) PCT Filed: May 11, 2011
(86) PCT No.: PCT/CN2011/073958

§ 371 Date: Jan. 23, 2014

(51) Int. Cl. B01D 35/157; F16K 1/14

(52) U.S. Cl. CPC B01D 35/1573; F16K 1/14
USPC 210/767; 210/450; 210/234; 251/337

(57) ABSTRACT

A filter cartridge is provided that is designed to actuate a valve that controls fluid flow into an outlet for discharging filtered fluid. The valve receives a ball at a first position which is axially movable between the first position and a second position. If a filter cartridge is not installed or an inappropriately designed filter cartridge is installed, the ball is moved from the first position to the second position to seal an outlet opening of the outlet. If the described filter cartridge is installed, the ball is retained at the first position by a holding member and the valve allows filtered fluid flow into the outlet opening.

### FIELD

This disclosure generally pertains to the field of fluid filtration, and more particularly to fluid filtration systems designed to safe-guard against damage to components of a protected system, for example, fuel injectors and associated components of an engine, and system malfunctions resulting from a missing or incorrect fluid filter.

### BACKGROUND

It is known to use a valve in a fluid filter housing to control fluid flow through the housing. One example of such a valve in a fluid filter housing is sometimes referred to as a “no filter, no run” valve, where the valve prevents flow of fluid to the engine if no filter is installed or if the incorrect filter is installed. In this type of system, not only must a filter be present, but the correct filter must be used, in order to allow fluid to flow past the valve to the engine in sufficient quantities to allow the engine to function properly.

### SUMMARY

Improvements to “no filter, no run” fluid filtration systems and components used in such systems, and a method for controlling fluid flow out of a filter are described. In a “no filter, no run” fluid filtration system, fluid flow to a downstream component(s) is prevented if a filter cartridge is not installed or an inappropriately designed filter cartridge is installed. An appropriately designed filter cartridge is required to be installed in order to permit fluid flow. This safeguards against damage to downstream components and malfunctions of equipment in which the fluid filtration system is used. The type of “no filter, no run” fluid filtration systems that can utilize the described improvements can be a number of systems including, but not limited to, a fuel filtration system, for example on an engine such as a diesel or gasoline engine, a hydraulic fluid filtration system in a hydraulic system, other engine fluid filtration systems on diesel or gasoline engines, as well as filtration systems used in non-engine applications.

As described further herein, a filter cartridge is provided that is designed to actuate a valve that controls fluid flow into an outlet for discharging filtered fluid. The valve has a ball received inside the valve which is axially movable between a first position and a second position. If the described filter cartridge is installed, the ball is retained at the first position and the valve allows filtered fluid access to the outlet opening. If a filter cartridge is not installed or an inappropriately designed filter cartridge is installed, the ball is moved to the second position to seal the outlet opening.

In one embodiment, a filter cartridge includes filtering media defining an interior space. The filtering media has a first end and a second end. A first endcap is coupled to the first end of the filtering media and a second endcap is coupled to the second end of the filtering media. The second endcap includes an annular perimeter portion secured to the second end of the filtering media, and a central portion extending axially from the annular perimeter portion into the interior space and defining a recess inside the interior space. The central portion includes a side wall and a bottom closure. The side wall extends axially between the annular perimeter portion and the bottom closure and surrounds the recess together with the bottom closure. The side wall has at least one perforation such that the interior space is in fluid communication with the recess. A seal mechanism is connected to the bottom closure of the second endcap.

The bottom closure has an opening located at the center of the bottom closure and the seal mechanism includes an axially facing seal received by the opening of the bottom closure. Alternatively, the bottom closure is closed and the seal mechanism includes an axially facing seal received by a central recess located at the central of the bottom closure.

In another embodiment, a filter apparatus includes a filter head defining an outlet having an outlet opening for discharging filtered fluid. A valve has a valve body extending axially from a first end to a second end with the first end connected to the filter head. The valve body has a first end opening at the first end, a second end opening at the second end and at least one side opening between the first end and the second end. The first end opening and the second end opening axially face each other and are in fluid communication with each other and with the side opening and the outlet opening. A ball is receivable inside the valve body. The ball is axially movable between a first position at which filtered fluid flows into the outlet opening and into the outlet and a second position preventing fluid flow through the outlet opening into the outlet. The valve further has a holding member between the side opening and the second end of the valve body to retain the ball at the first position.

In another embodiment, a filter assembly includes a filter housing and a filter cartridge. The filter housing includes a housing body defining a filter cartridge space. The filter cartridge space extends axially from a housing head to a closed end wall. The housing head defines an outlet having an outlet opening in fluid communication with the interior space for discharging filtered fluid.

The filter housing further includes a valve having a valve body extending axially from a first end to a second end with the first end connected to the housing head. The valve body has a first end opening at the first end, a second end opening at the second end and at least one side opening between the first end and the second end. The first end opening and the second end opening axially face each other and in fluid communication with each other and with the side opening and the outlet opening. A ball is receivable inside the valve body. The ball is axially movable between a first position at which filtered fluid flows into the outlet opening and into the outlet and a second position preventing fluid flow through the outlet opening into the outlet. The valve further has a holding member adjacent the second end of the valve body configured to retain the ball at the first position.

The first end opening of the valve body is axially facing the outlet opening, when the ball is at the second position, the ball is disposed adjacent the first end opening configured to seal the outlet opening from the first end opening. Alternatively, the housing head has a passageway fluidly connecting the outlet opening and the first end opening of the valve body; when the ball is at the second position, the ball is disposed inside the passageway to seal the outlet opening from the passageway.

The filter cartridge is received by the housing body inside the filter cartridge space where a filtering media defines an interior space. The filtering media has a first end and a second end. A first endcap is coupled to the first end of the filtering media. A second endcap is coupled to the second end of the filtering media. The second endcap includes an annular perimeter portion secured to the second end of the filtering media. A central portion axially extends from the annular portion into the interior space and defines a recess inside the interior space. The central portion includes a side wall and a bottom closure. The side wall extends axially between the annular perimeter portion and the bottom closure. The side wall has at least one perforation such that the interior space is in fluid communication with the recess. A seal mechanism is connected to the bottom closure of the second endcap and is configured to seal the second end opening of the valve body and prevent fluid flow from the interior space into the valve body through the second end opening of the valve body.

The bottom closure of the second endcap has an opening located at the center of the bottom closure and the seal mechanism includes an axially facing seal received by the opening of the bottom closure. Alternatively, the bottom closure of the second endcap is closed and the seal mechanism includes an axially facing seal received by a central recess located at the central of the bottom closure.

In another embodiment, a filter valve includes a valve body extending axially from a first end to a second end. The valve body has a first end opening at the first end, a second end opening at the second end and at least one side opening between the first end and the second end. The first end opening and the second end opening axially face each other and are in fluid communication with each other and with the side opening. A ball is receivable inside the valve body. The ball is axially movable between the first end and the second end. A holding member adjacent the second end of the valve body is configured to retain the ball between the side opening and the second end opening.

In another embodiment, a method for controlling fluid flow out of a filter includes positioning a ball inside a valve at a first position. The valve extends axially from a first end to a second end. The valve has a first end opening at the first end, a second end opening at the second end, and at least one side opening between the first end and the second end. The first end opening and the second end opening axially face each other and are in fluid communication with each other and with the side opening. The ball is axially movable inside the valve and is releasably retained by a holding member at the first position between the side opening and the second end opening of the valve. The method further includes connecting the valve to a filter head of the filter so that the side opening is in fluid communication with an outlet opening of the housing head. The method further includes allowing filtered fluid to flow through the side opening, through the outlet opening and into the outlet when a correct filter cartridge is installed, the first end opening of the valve body is sealed and the ball is retained at the first position by the holding member so that the side opening is in fluid communication with the outlet opening. When no filter cartridge is installed or an incorrect filter cartridge is installed, fluid is not allowed to flow into the outlet by moving the ball from the first position to a second position where the ball seals the outlet opening from the side opening.

### DRAWINGS

FIG. 1 is a cross-sectional side view of one embodiment of a no filter no run valve assembled with a filter housing and a filter cartridge installed herein.

FIG. 2 is an exploded side perspective view of the assembly of the filter housing, the filter cartridge and the valve of FIG. 1.

FIG. 3 is a partial side sectional view of the filter housing of FIG. 1 with the installed filter cartridge showing a valve described herein being open.

FIG. 4 is a partial side sectional view of the filter housing of FIG. 1 showing the valve described herein being closed.

FIG. 5(a) is a side perspective view of the valve of FIG. 1 without the ball inside.

FIG. 5(b) is a side sectional view of the valve of FIG. 1 without the ball inside.

FIG. 6 is a cross-sectional side view of another embodiment of a no filter no run valve assembled with a filter housing and a filter cartridge installed herein.

FIG. 7 is a partial side sectional view of the filter housing of FIG. 6 with the installed filter cartridge showing a valve described herein being open.

FIG. 8 is a partial side sectional view of the filter housing of FIG. 6 showing the valve described herein being closed.

FIG. 9(a) is a side perspective view of one embodiment of an endcap of the filter cartridge of FIGS. 6-8.

FIG. 9(a) is a side sectional view of the endcap of FIG. 9(a).

### DETAILED DESCRIPTION

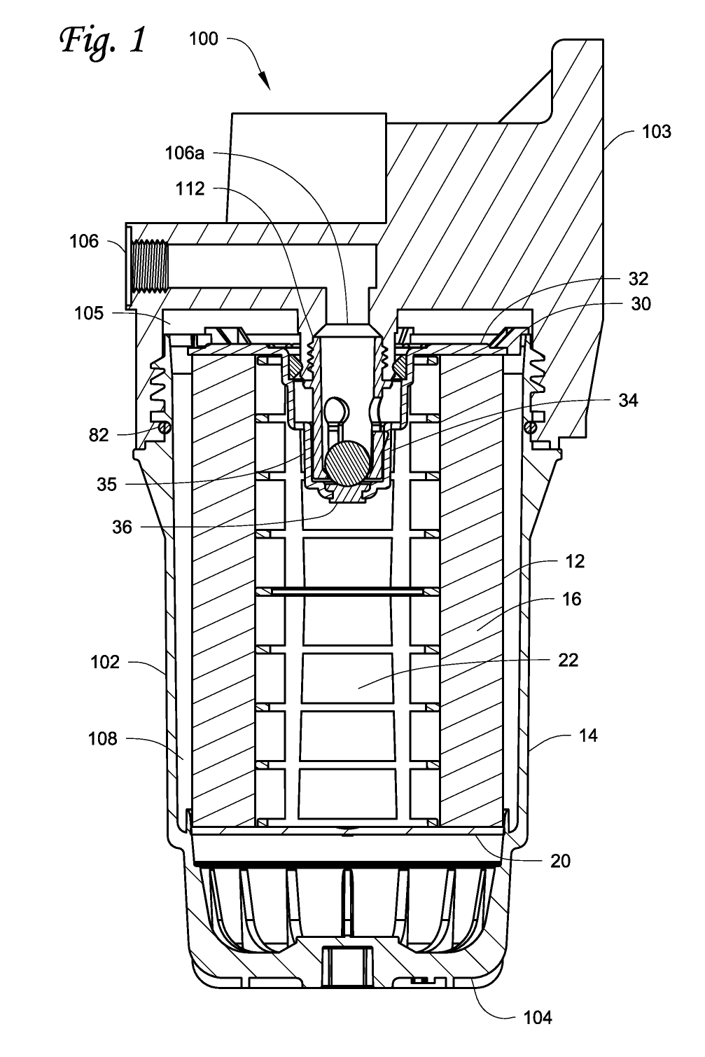

FIG. 1 illustrates one embodiment of a “no filter, no run” design. FIG. 1 shows an assembly 100 that includes a filter cartridge 12 disposed within a filter housing 14. The assembly 100 can be, for example, used in a fuel system for filtering fuel, for example diesel fuel, before the fuel reaches components of a protected system, for example a fuel injection pump or fuel injectors. While this description will hereinafter describe the filter cartridge and filter housing as being used to filter fuel, it is to be realized that the concepts described herein can be used for filtering other fluids. For example, in appropriate circumstances, one or more of the concepts described herein can be applied to other types of assemblies that filter other types of fluids, for example lubrication, hydraulic and other liquids, as well as air.

In the example described herein, the filter cartridge 12 is configured to filter fuel. With reference to FIGS. 1-4, the filter cartridge 12 includes filter media 16, an upper endcap 30 secured to an upper end of the media 16, and a bottom endcap 20 secured to a bottom end of the media 16. The ends of the filter media 16 are secured to the endcaps 20, 30 in any suitable manner, for example embedding the media into the endcaps or by using an adhesive to adhere the media to the endcaps. The endcaps 20, 30 can be made of, for example, a composite material such as plastic, or other material compatible with the fuel or other fluid being filtered.

The filter media 16, which in the illustrated example is a cylindrical ring in lateral cross-section, defines an interior space 22. The filter media 16 can take on any lateral cross-sectional shape, for example the cylindrical ring, triangular, oval, as long as it defines interior space 22. In the example described herein, the interior space 22 defines a clean fuel side that receives filtered fuel that has been filtered by the media 16, in which case the filter cartridge 12 is configured for outside-in flow.

The filter media 16 is designed to remove unwanted contaminants from the fuel. For example, the filter media 16 can be configured to remove soft and solid particulate contaminants and/or water from the fuel. It will be appreciated that one would know the appropriate filter media to use for filtering depending on the fluid to be filtered, e.g., fuel, oil, hydraulic, coolant, air, or other fluid. The type of filter media is not further described.

With continued reference to FIGS. 1-4, in one embodiment, the bottom endcap 20 is closed, i.e. the bottom endcap 20 is devoid of openings for fuel to flow therethrough. In appropriate circumstances, the bottom endcap may include an opening so that a standpipe is receivable through the opening in the bottom endcap of the filter cartridge. A standpipe is known to those of ordinary skill in the art and not further described.

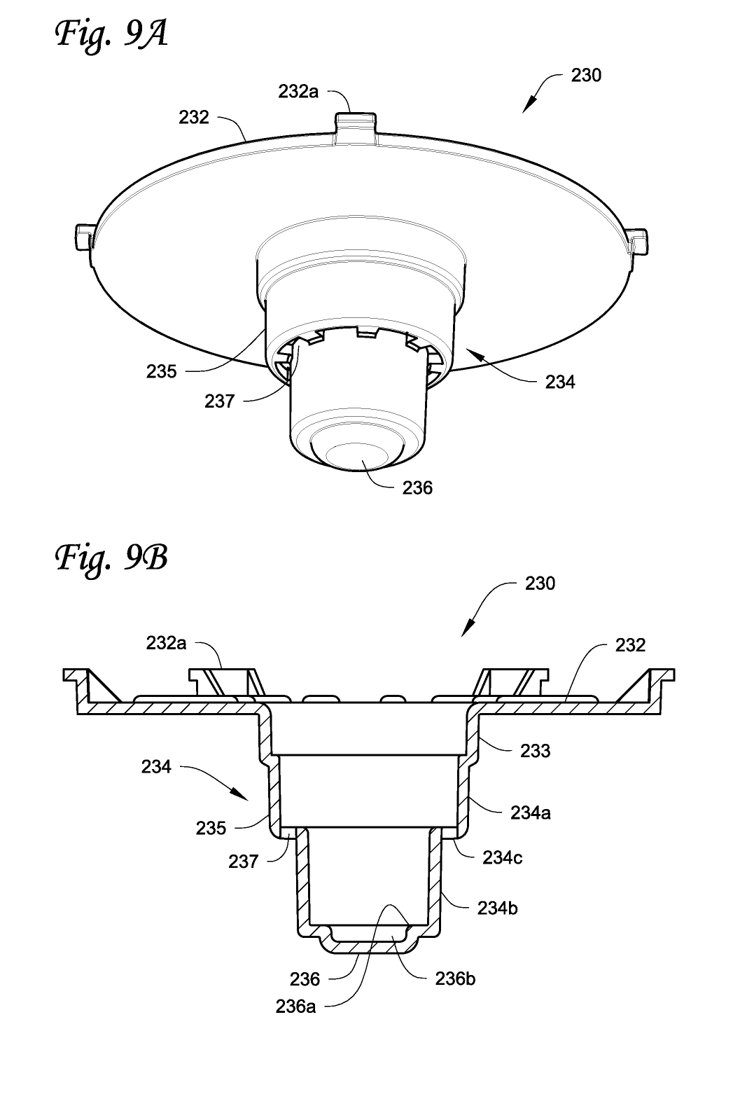

The upper endcap 30 includes a generally annular perimeter portion 32 that is attached to the upper end of the filter media 16. A central portion 34 extends axially downward from the perimeter portion 32 toward and into the interior space 22. The central portion 34 includes a side wall 35 and a bottom closure 36. The upper endcap 30 is the same as an endcap 230 shown in FIGS. 9(a) and 9(b) except for construction of the bottom closure 36 and a seal mechanism connected therein, which will be further described herein.

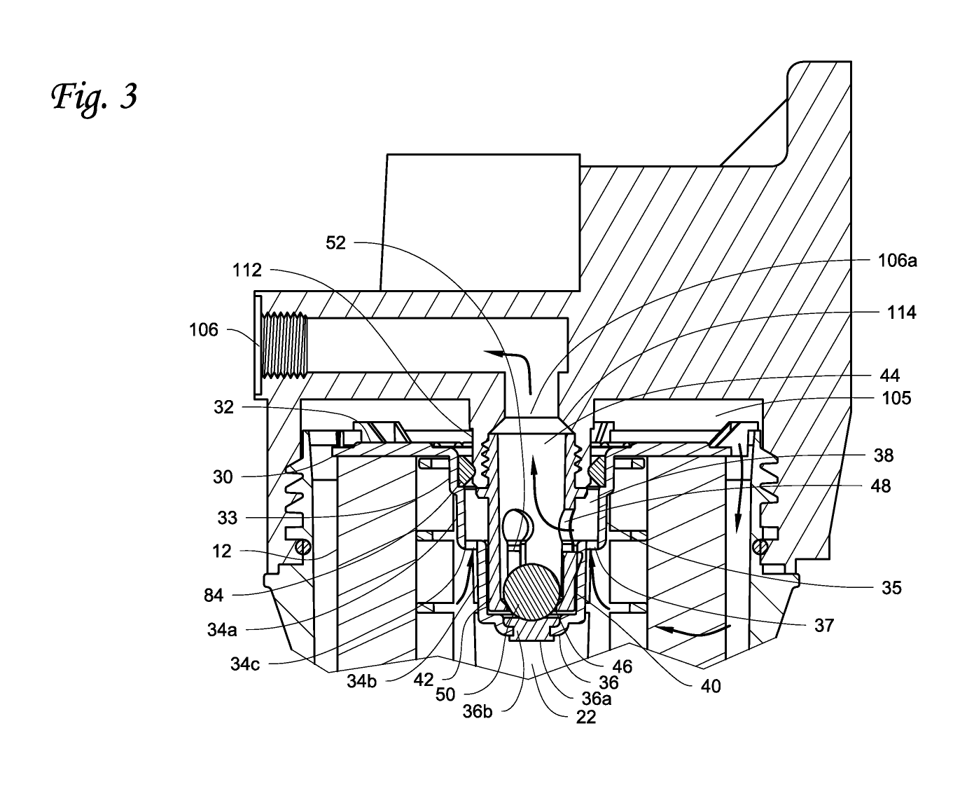

The side wall 35 has a generally tubular shape and includes a base end 33 connected to an inner perimeter of the annular perimeter portion 32, a first section 34a extending axially from the base end 33, and a second section 34b coaxial with the first section 34a and extending axially to the bottom closure 36 (see FIG. 3). An annular connection section 34c radially connects the tubular sections 34a and 34b. The annular connection section 34c has perforations 37 which allow filtered fluid flow across the side wall 35. It is to be understood that the axially extending sections 34a and 34b can also include perforations.

The bottom closure 36 includes an axially facing seal 36a which is hermetically received by an opening 36b located at the center of the bottom closure 36. The opening 36b is firmly sealed by the seal 36a so that the bottom closure 36 is closed off and is devoid of fluid flow openings.

The central portion 34 defines a recess 38 surrounded by the side wall 35 and the bottom closure 36. The recess 38 is in fluid communication with the interior space 22 through the perforations 37 of the annular connection section 34c.

As shown in FIGS. 1-4, the illustrated example of the filter housing 14 includes a housing body that has a side wall 102 and an end wall 104. The side wall 102 and the end wall 104 define a filter cartridge space 108 that is large enough to receive the filter cartridge 12 therein, with the end wall 104 forming a closed end of the space 108. The housing body has an open end generally opposite the end wall 104. In use, the housing body is closed by a housing head 103 that closes off the space 108. A gasket 82 is disposed at the upper end perimeter of the side wall 102 for sealing engagement with the housing head 103.

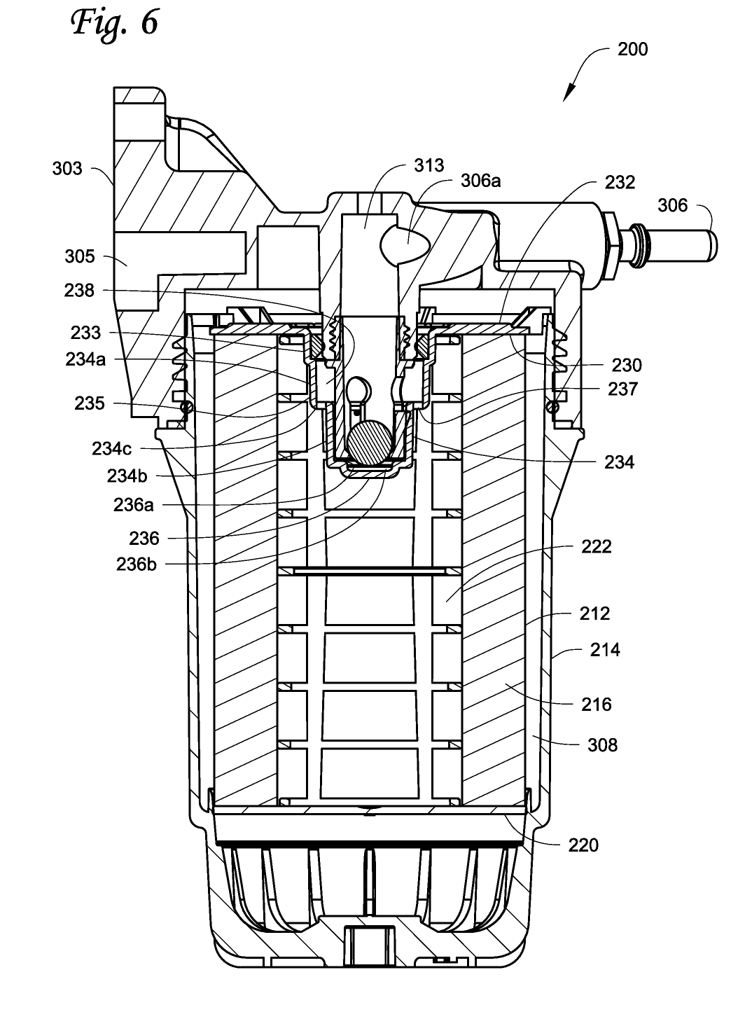

The housing head 103 defines an inlet 105 through which fuel to be filtered enter the space 108, and an outlet 106, through which fuel exits on its way to the engine. An inlet, such as the inlet 105 partially shown in FIGS. 1-4 and an inlet 305 partially shown in FIGS. 6-8, is known and not further described. The outlet 106 includes an outlet opening 106a facing axially downward. It is to be understood that the outlet opening 106a can face other directions as long as filtered fluid can access to the outlet 106.

An annular skirt 112 extends axially downward from the outlet opening 106a and has a chamfer 114 that surrounds the outlet opening 106a. The annular skirt 112 has a larger perimeter than the outlet opening 106a.

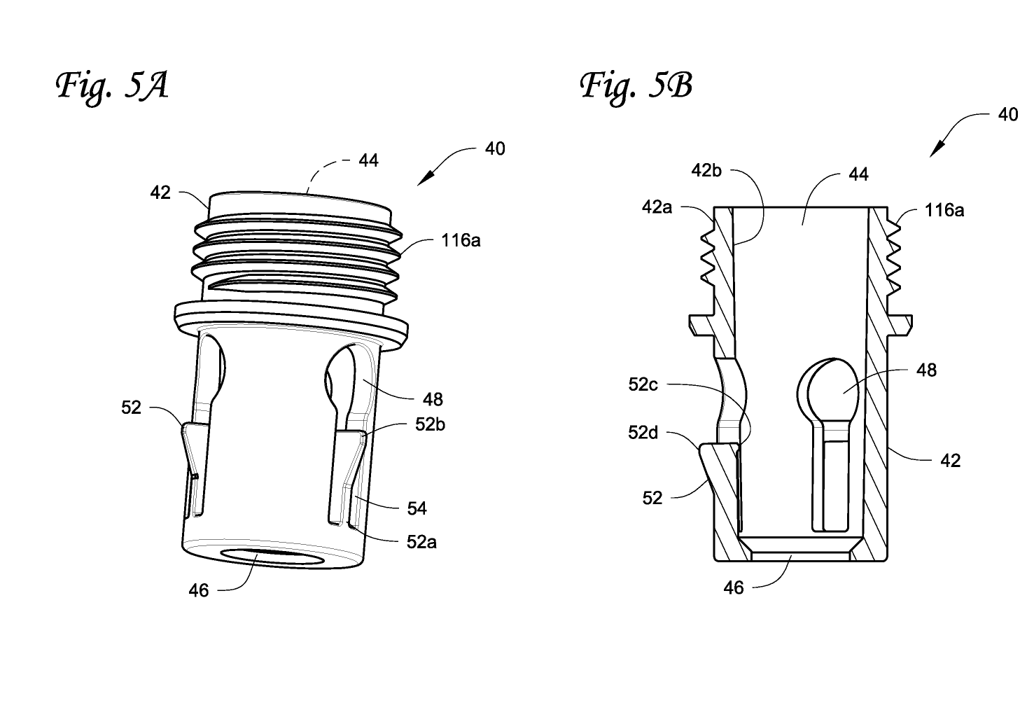

A valve 40 is releasably connected to the annular skirt 112. As shown in FIGS. 5a and 5b, the valve 40 includes a valve body 42 that extends axially from a first end to a second end. The valve body 42 has a generally cylindrical shape with an outside surface 42a and an internal surface 42b. However, it is appreciated that the valve body can be other shapes, such as a non-circular shape. It is also to be understood that the valve body may have a non-straight shape, such as an “L” shape. The first end of the valve body 42 is connected to the annular skirt 112 through threads 116a on the outside surface 42a and threads 116b on the internal surface of the annular skirt 112. It is to be understood that instead of a thread connection, the valve 40 can be connected to the housing head 103 through other suitable ways, for example, snap-fit.

The valve 40 has an opening 44 at the first end and an opening 46 at the second end. The openings 44 and 46 are axially facing one another and in fluid communication with each other. The opening 44 at the first end has a generally circular shape and is in communication with the outlet opening 106a where the valve 40 is connected to the housing head 103. The opening 46 is generally circular and has a diameter slightly smaller than the internal perimeter of the valve body 42. It is to be understood that the openings 44 and 46 can be any other shapes and can face other directions as long as fluid can flow into the valve body 42 through the opening 46 and flow outside the valve body through the opening 44.

The valve body 42 further includes at least one radially facing fluid opening 48 at the valve body 42 between the first and second ends. The exemplary valve body 42 has three annularly disposed fluid openings 48. It is to be understood that any other number of fluid openings can be used and the fluid opening 48 can face other directions as long as fluid can flow into the valve body 42 through the opening 48.

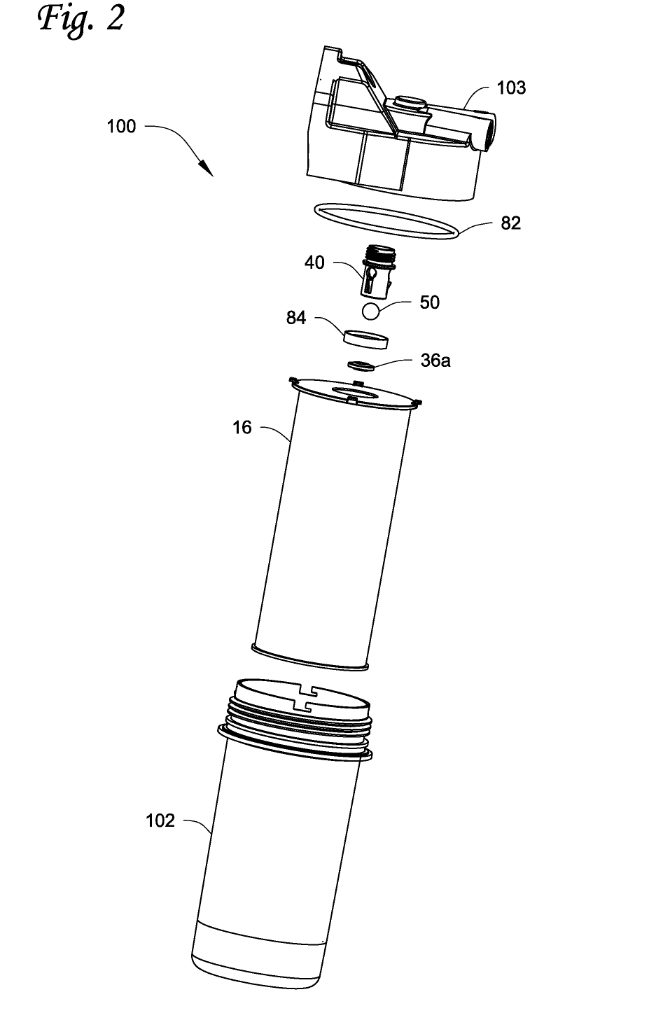

Turning back to FIGS. 2-4, a ball 50 is received by the valve body 42. The ball 50 is sized to be axially movable inside the valve body 42 between a first position and a second position. In one embodiment, the ball 50 has a diameter nearly close to the internal perimeter of the valve body 42 so that the ball 50 can slide axially on the internal surface 42b. The ball 50 has a generally round shape, in some embodiments, is generally rigid and can be made of, for example, a plastic material or other material compatible with the fuel or other fluid being filtered. It is to be understood that the ball can be any shape as long as it is axially movable inside the valve body 42.

A holding member is disposed between the fluid opening 48 and the opening 46 at the second end of the valve body 40, as shown in FIGS. 5(a) and 5(b). The holding member includes a biasing member such as, for example, at least one spring strip 52. In one embodiment, the spring strip 52 extends axially upward from a base end 52a adjacent the opening 46 to a free end 52b. The spring strip 52 is disposed within a slot 54 which has one end that includes the fluid opening 48. The free end 52b has a protrusion 52c projecting radially inwardly that is sized to releasably confine the ball 50 at the first position. The spring strip 52 is flexible with free end 52b radially movable. Upon a force pointing axially upward, the ball 50 can escape the confinement of the holding member and move upward.

In some embodiments, the free end 52b further has a protrusion 52d projecting radially outwardly. When an appropriately designed filter cartridge, such as the filter cartridge 12 is installed, the inner surface of the second section 34b of the upper endcap 30 is sized to push the protrusion 52d radially inward. The spring strip 52 is flexible so that the free end 52b would move radially inward and the ball would be retained by the inward protrusion 52c at the first position.

When the ball 50 is at the first position, as shown in FIG. 3, the ball 50 is confined by the holding member between the opening 48 and the second end of the valve body 42 and can loosely block the opening 46 therein. The diameter of the ball 50 is larger than that of the opening 46 to prevent the ball 50 from sliding out of the valve body 40 at the second end.

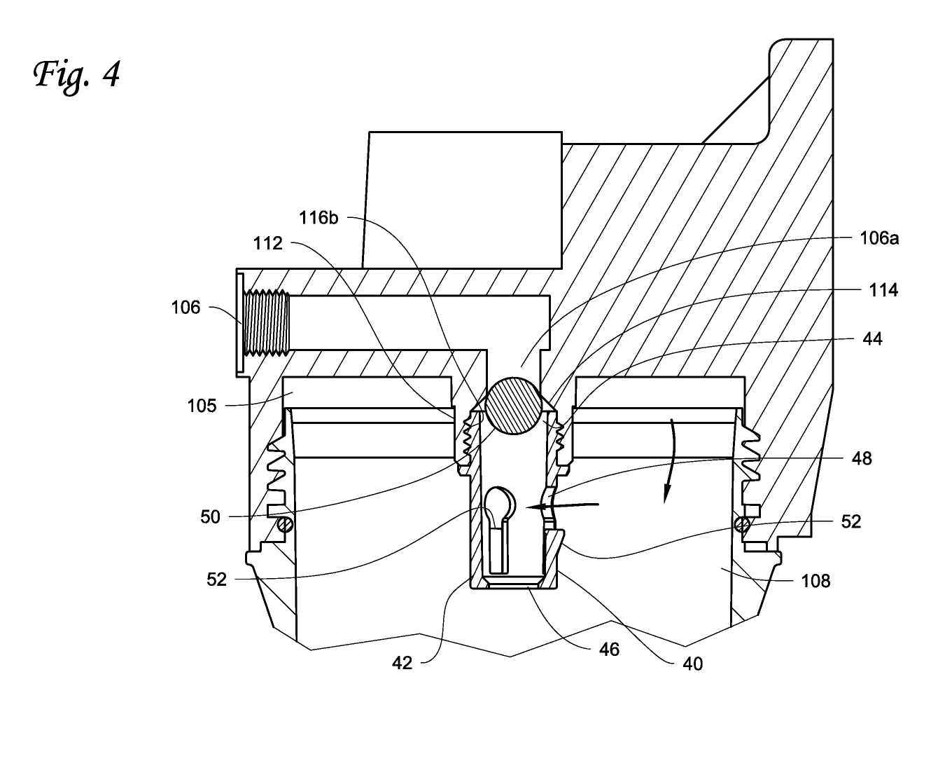

When the ball 50 is at the second position, as shown in FIG. 4, the ball 50 is disposed to seal the outlet opening 106a. The ball 50 is sized with respect to the chamfer 114 so that when the ball is pressed against the chamfer 114 upon a force, a fluid seal is formed therein. It will be appreciated that an annular gasket may be attached to the chamfer 114 to enhance the fluid seal. The perimeter of the ball 50 is larger than the perimeter of the outlet opening 106a to prevent the ball 50 from sliding into the outlet 106. In this manner, the ball 50 is axially movable between the first position and the second position without falling into the space 108 or sliding into the outlet 106.

As shown in FIG. 3, upon installation of an appropriately designed filter cartridge, for example the filter cartridge 12, the valve 40 is received by the recess 38 of the upper endcap 30. The opening 46 at the second end of the valve body 42 is sealed from the interior space 22 by the seal 36a at the bottom closure 36 of the upper cap 30. The ball 50 sits on the seal 36a and is separated from the interior space 22.

As described above, the holding member, e.g., the spring strips 52, releasably retains the ball 50 at the bottom end of the valve body 42. It is to be understood that the self-gravity of the ball alone may not be strong enough to hold the ball 50 in the first position, so the holding member may be employed. It is also appreciated that the holding member can retain the ball at the first position when the valve is in other orientations than the up-right orientation shown in FIG. 3. Filtered fluid inside the interior space 22 is permitted to access the outlet opening 106a through the perforations 37 at the annular connection section 34c of the upper endcap 30, through the at least one radially facing fluid opening 48 of the valve body 42, and into the outlet 106, as shown by arrows in FIG. 3. Therefore, with the ball 50 being disposed at the bottom end of the valve body 42, the valve 40 is opened. A gasket 84 may be disposed between the base end 33 of the central portion 34 and the outside of the annular skirt 112 for sealing engagement of the endcap 30 with the housing head 103 and separating dirty fluid from filtered fluid.

As shown in FIG. 4, when no filter cartridge is installed or an inappropriate filter cartridge is installed, the opening 46 of the valve body 42 is not sealed from the space 108 and fluid can flow into the inside of the valve body 42 through the opening 46. With the ball 50 sitting on the opening 46 inside the valve body 42, the fluid flow generates a fluid pressure on the ball 50, pointing axially upward. Upon the fluid pressure, the ball 50 overcomes the confinement of the holding member, for example, the spring strip 52 and moves axially upward inside the valve body 42 from the second end to the first end. At the first end of the valve body 42, the ball 50 is pressed against the chamfer 114 and seals the outlet opening 106a. In some embodiments, the assembly 100 in use also generates a negative pressure in the outlet 106 compared to that of the space 108 inside the housing. The ball 50 is sucked by the negative pressure, moves upward and seals the outlet opening 106a therein. It is to be understood that the fluid pressure and the negative pressure can work together or separately to actuate the ball 50.

As illustrated in FIG. 3, when an appropriately designed filter cartridge, such as the filter cartridge 12 is installed, the bottom closure 36 of the filter cartridge 12 seals the second end opening 46 of the valve 40 so that the valve 40 is open and filtered fluid can flows into the valve 40 and into the outlet 106.

FIG. 6 illustrates another embodiment of a “no filter, no run” design. FIG. 6 shows an assembly 200 that includes a filter cartridge 212 disposed within a filter housing 214. The assembly 200 is similar to the assembly 100 except for a few modifications to the filter cartridge and the housing head as will be described herein. More specifically, the bottom closure of the upper endcap of the filter cartridge in the assembly 200 is closed and has a recess to receive a seal; the housing head of the assembly 200 has a passage to connect the outlet opening and the valve where the outlet opening is modified. It will be appreciated that the housing head 103 in the assembly 100 can be used in the assembly 200. Likewise, the housing head in the assembly 200 can be used in the assembly 100. The filter cartridge 12 in the assembly 100 can be used in the assembly 200. Likewise, the filter cartridge in the assembly 200 can be used in the assembly 100.

Similar to the assembly 100, the assembly 200 can be, for example, used in a fuel system for filtering fuel, for example diesel fuel, before the fuel reaches a protected system, for example a fuel injection pump or fuel injectors.

With reference to FIGS. 6-8, the filter cartridge 212 includes filter media 216, an upper endcap 230 secured to an upper end of the media 216, and a bottom endcap 220 secured to a bottom end of the media 216.

As shown in FIGS. 9a and 9b, the upper endcap 230 includes a generally annular perimeter portion 232 that is attached to the upper end of the filter media 216. The perimeter portion 232 has tabs 232a connected to the housing. It is to be understood that a suitable number of tabs 232a can be used. For example, four tabs are used in FIG. 9a and six tabs may be used in FIG. 9b. A central portion 234 extends axially from the perimeter portion 232 toward and into the interior space 222 the filter media 16. The central portion 234 includes a side wall 235 and a bottom closure 236 that closes the central portion 234.

The side wall 235 has a generally tubular shape and includes a base end 233 connected to an inner perimeter of the annular perimeter portion 232, a first section 234a extending axially from the base end 233, and a second section 234b coaxial with the first section 234a and extending axially to the bottom closure 236. An annular connection section 234c radially connecting the sections 234a and 234b. The annular connection section 234c has perforations 237 which allow filtered fluid flow across the side wall 235. It is to be understood that the axially extending sections 234a and 234b can also include perforations. The bottom closure 236 defines a recess 236b at the center of the bottom closure 236 to hermetically receive an axially facing circular seal 236a. As shown, the bottom closure 236 is closed in that it may be continuous and devoid of fluid flow openings.

Returning back to FIGS. 6-8, the central portion 234 defines a recess 238 extending into the interior space 222 of the filter media 16. The recess 238 has an axially facing opening defined by the inner perimeter of the perimeter portion 232 at one end and is separated from the interior space 222 by the bottom closure 236 at the other end. The recess 238 is in fluid communication with the interior space 222 through the perforations 237 at the side wall 235.

The illustrated example of the filter housing 214 defines a filter cartridge space 308 that is large enough to receive the filter cartridge 212 therein. The housing has an open end in use being closed by a housing head 303 that closes off the space 308.

The housing head 303 defines an inlet 305 and an outlet 306. The outlet 306 includes an outlet opening 306a facing radially and in fluid communication with the interior space 222 through a generally vertical passage 313. It is to be understood that the outlet opening 306a can face other directions as long as filtered fluid can access to the outlet opening 306a through the passage 313.

An annular skirt 312 extends axially downward from the passage 313 and defines an axially facing opening 313a in fluid communication with the passage 313.

A valve 240 is releasably connected to the annular skirt 312. Similar to the valve 40 in FIGS. 1-4, 5a and 5b, the valve 240 includes a valve body 242 that extends axially from a first end to a second end with the first end connected to the annular skirt 312 through, for example, threads. It is to be understood that instead of by a thread connection, the valve 240 can be connected to the housing head 303 through other suitable ways, for example, snap-fit.

The valve body 242 has an opening 244 at the first end and an opening 246 at the second end. The openings 244 and 246 are axially facing one another and in communication with each other. The opening 244 at the first end is in fluid communication with the passage 313 through the opening 313a. The opening 246 at the second end allows fluid to flow into the valve body 242, into the passage 313, and into the outlet 306.

Similar to the valve body 42, the valve body 242 further includes at least one radially facing side fluid opening 248 that is disposed annularly at the valve body 242 between the first and second ends. Fluid can flow into the valve body 242 through the opening 248.

A holding member 252 is disposed between the fluid opening 248 and the opening 246 at the second end of the valve body 240. The holding member can have a similar structure to that in the assembly 100.

A ball 250 is received by the valve body 242. The ball 50 is sized to be axially movable inside the valve body 242 and into the passage 313 between a first position and a second position.

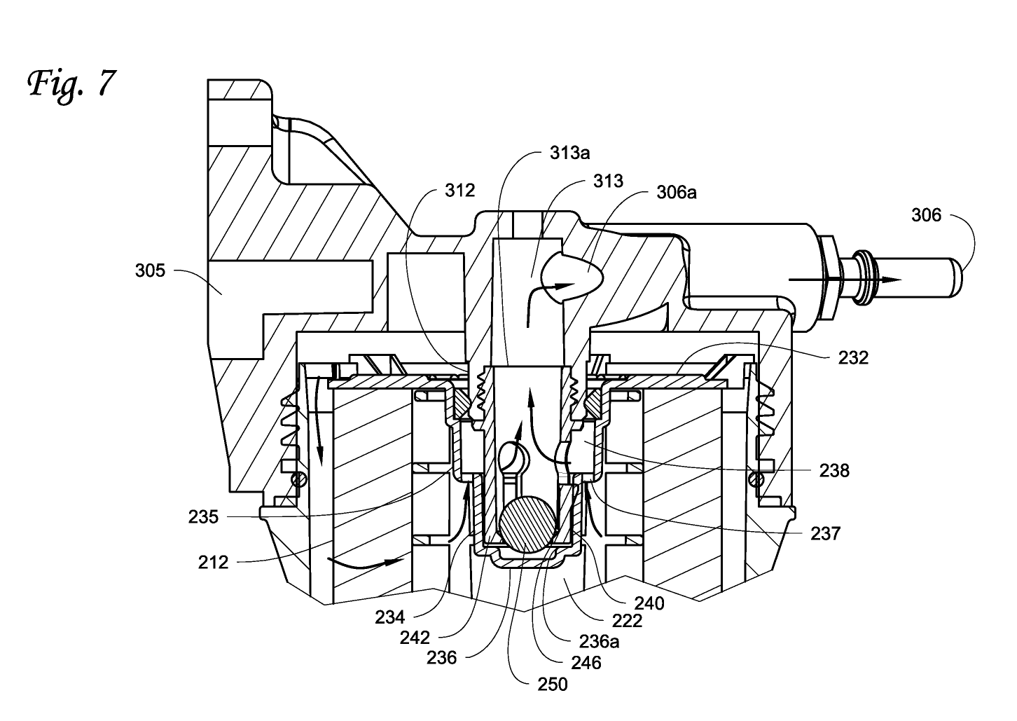

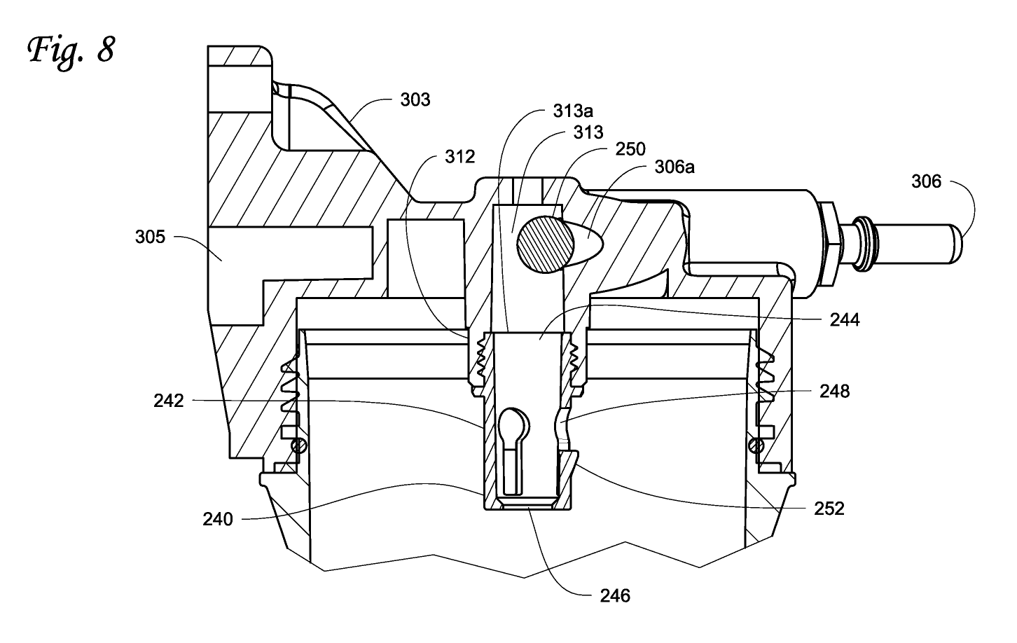

When the ball 250 is at the first position, as shown in FIG. 7, the ball 250 sits at the bottom end of the valve body 242 and can loosely block the opening 246 therein. The diameter of the ball 250 is larger than that of the opening 246. When the ball 250 is at the second position, as shown in FIG. 8, the ball 250 is disposed to seal the outlet opening 306a. The perimeter of the ball 250 is larger than the perimeter of the outlet opening 306a to prevent the ball from sliding into the outlet 306. In this manner, the ball is axially movable between the first position and the second position without falling into the space 308 or sliding into the outlet 306.

As shown in FIG. 7, upon installation of an appropriately designed filter cartridge, for example, the filter cartridge 212, the valve 240 is received by the recess 238 of the upper endcap 230. The opening 246 at the second end of the valve body 242 is sealed from the interior space 222 by the seal 236a at the bottom closure 236 of the upper cap 230 between the ball 250 and the recess 236b. As shown in FIG. 9b, the seal 236a is on the bottom closure 236. The ball 250 sits on the seal 236a and is retained by the holding member of the valve 240 at the bottom end of the valve 240. Filtered fluid inside the interior space 222 is permitted to access the outlet opening 306a through the perforations 237 at the side wall 235 of the upper endcap 230, through the at least one radially facing fluid opening 248 of the valve body 42, into the passage 313 and into the outlet 306, as shown by arrows. Therefore, with the ball 250 being retained by the holding member at the bottom end of the valve body 242, the valve 240 is opened.

As shown in FIG. 8, when no filter cartridge is installed or an inappropriate filter cartridge is installed, the opening 246 of the valve body 242 is not sealed from the space 308 of the housing and fluid can flow into the valve body 242 through the opening 246. With the ball 250 sitting on the opening 246 inside the valve body 242, the fluid flow generates a fluid pressure on the ball 250, pointing axially upward during operation. Upon the fluid pressure, the ball 250 overcomes the confinement of the holding member 252 and moves axially upward inside the valve body 242 and into the passage 313. The ball 250 is pressed firmly against the outlet opening 306a and seals the outlet opening 306a. It is appreciated that a seal, for example, an annular gasket may be attached to the outlet opening 36a to have a close contact with the ball 250 and enhance the seal. It is also to be understood that the negative pressure inside the outlet 306 can also actuate the ball 250.

The invention may be embodied in other forms without departing from the spirit or novel characteristics thereof. The embodiments disclosed in this application are to be considered in all respects as illustrative and not limitative. The scope of the invention is indicated by the appended claims rather than by the foregoing description; and all changes which come within the meaning and range of equivalency of the claims are intended to be embraced therein.

1. A filter cartridge comprising:
filtering media defining an interior space, the filtering media having a first end and a second end;
a first endcap coupled to the first end of the filtering media;
a second endcap coupled to the second end of the filtering media;
the second endcap including an annular perimeter portion secured to the second end of the filtering media, and a central portion extending axially from the annular perimeter portion into the interior space and defining a recess inside the interior space;
the central portion including a side wall and a bottom closure, the side wall extending axially between the annular perimeter portion and the bottom closure and surrounding the recess together with the bottom closure;
the side wall having at least one perforation such that the interior space is in fluid communication with the recess; and
a seal mechanism connected to the bottom closure of the second endcap.

2. The filter cartridge of claim 1, wherein the side wall includes a first section axially extending from the annular perimeter portion, a second section coaxial with the first section and extending to the bottom closure, and an annular connection section connecting the first and second sections.

3. The filter cartridge of claim 1, wherein the bottom closure has an opening located at the center of the bottom closure and the seal mechanism includes an axially facing seal received by the opening of the bottom closure.

4. The filter cartridge of claim 1, wherein the bottom closure is closed and the seal mechanism includes an axially facing seal received by a central recess located at the center of the bottom closure.

5. A filter apparatus, comprising:
a filter head defining an outlet having an outlet opening for discharging filtered fluid;
a valve having a valve body extending axially from a first end to a second end with the first end connected to the filter head, the valve body having a first end opening at the first end, a second end opening at the second end and at least one side opening between the first end and the second end, the first end opening and the second end opening axially facing each other and in fluid communication with each other and with the side opening and the outlet opening;
a ball receivable inside the valve body, the ball being axially movable between a first position at which filtered fluid flows into the outlet opening and into the outlet and a second position preventing fluid flow through the outlet opening into the outlet; and
the valve further having a holding member between the side opening and the second end of the valve body, configured to releasably retain the ball at the first position.

6. The filter apparatus of claim 5, further comprising a shell body defining a filter cartridge space for receiving a filter cartridge, the filter cartridge space extending axially from the filter head to a closed end wall.

7. The filter apparatus of claim 5, wherein the filter head has an annular skirt extending axially and being configured to connect the valve body to the filter head.

8. The filter apparatus of claim 5, wherein the first end opening of the valve body is axially facing the outlet opening, when the ball is at the second position, the ball is disposed adjacent the first end opening configured to seal the outlet opening from the first end opening.

9. The filter apparatus of claim 5, wherein the filter head has a passageway fluidly connecting the outlet opening and the first end opening of the valve body; when the ball is at the second position, the ball is disposed inside the passageway to seal the outlet opening from the passageway.

10. The filter apparatus of claim 5, wherein the holding member includes at least one spring strip disposed in a slot within the valve body, the spring strip extending axially from a base end to a free end.

11. The filter apparatus of claim 10, wherein the spring strip has an inwardly projecting protrusion at the free end configured to confine the ball at the first position.

12. The filter apparatus of claim 10, wherein the spring strip has an outwardly projecting protrusion at the free end.

13. A filter assembly, comprising:
a filter housing that includes:
a housing body defining a filter cartridge space, the filter cartridge space extending axially from a housing head to a closed end wall, the housing head defining an outlet having an outlet opening in fluid communication with the interior space for discharging filtered fluid;
a valve having a valve body extending axially from a first end to a second end with the first end connected to the housing head, the valve body having a first end opening at the first end, a second end opening at the second end and at least one side opening between the first end and the second end, the first end opening and the second end opening axially facing each other and in fluid communication with each other and with the side opening and the outlet opening;
a ball receivable inside the valve body, the ball being axially movable between a first position at which filtered fluid flows into the outlet opening and into the outlet and a second position preventing fluid flow through the outlet opening into the outlet; and
the valve further having a holding member adjacent the second end of the valve body configured to releasably retain the ball at the first position;
and
a filter cartridge received by the housing body inside the filter cartridge space, including:
a filtering media defining an interior space, the filtering media having first and second ends;
a first endcap coupled to the first end of the filtering media;
a second endcap coupled to the second end of the filtering media;
the second endcap including an annular perimeter portion secured to the second end of the filtering media, and a central portion axially extending from the annular portion into the interior space and defining a recess inside the interior space;
the central portion including a side wall and a bottom closure, the side wall extending axially between the annular perimeter portion and the bottom closure and surrounding the recess together with the bottom closure;
the side wall having at least one perforation such that the interior space is in fluid communication with the recess; and
a seal mechanism connected to the bottom closure of the second endcap.

14. The filter assembly of claim 13, wherein the housing head has an annular skirt extending axially and is configured to connect the valve body to the housing head.

15. The filter assembly of claim 13, wherein the first end opening of the valve body is axially facing the outlet opening, when the ball is at the second position, the ball is disposed adjacent the first end opening configured to seal the outlet opening from the first end opening.

16. The filter assembly of claim 13, wherein the housing head has a passageway fluidly connecting the outlet opening and the first end opening of the valve body; when the ball is at the second position, the ball is disposed inside the passageway to seal the outlet opening from the passageway.

17. The filter assembly of claim 13, wherein the holding member includes at least one spring strip received by a slot defined by the valve body, the spring strip extending axially from a base end to a free end.

18. The filter assembly of claim 17, wherein the spring strip has an inwardly projecting protrusion at the free end configured to confine the ball at the first position.

19. The filter assembly of claim 17, wherein the spring strip has an outwardly projecting protrusion at the free end configured to engage the side wall of the central portion of the second endplate of the filter cartridge.

20. The filter assembly of claim 13, wherein the side wall includes a first section axially extending from the annular perimeter portion, a second section coaxial with the first section and extending to the bottom closure, and an annular connection section connecting the first and second sections.

21. The filter assembly of claim 13, wherein the bottom closure has an opening located at the center of the bottom closure and the seal mechanism includes an axially facing seal received by the opening of the bottom closure.

22. The filter assembly of claim 13, wherein the bottom closure is closed and the seal mechanism includes an axially facing seal received by a central recess located at the center of the bottom closure.

23. A filter valve comprising:
a valve body extending axially from a first end to a second end, the valve body having a first end opening at the first end, a second end opening at the second end and at least one side opening between the first end and the second end, the first end opening and the second end opening axially facing each other and in fluid communication with each other and with the side opening;
a ball receivable inside the valve body, the ball being axially movable between the first end and the second end; and
a holding member adjacent the second end of the valve body, configured to releasably retain the ball between the side opening and the second end opening.

24. The filter valve of claim 23, wherein the holding member includes at least one spring strip received by a slot defined by the valve body, the spring strip extending axially from a base end to a free end.

25. The filter valve of claim 24, wherein the spring strip has an inwardly projecting protrusion at the free end configured to confine the ball at the first position.

26. The filter valve of claim 24, wherein the spring strip has an outwardly projecting protrusion at the free end.

27. A method for controlling fluid flow out of a filter apparatus, comprising:
positioning a ball inside a valve body at a first position, the valve body extending axially from a first end to a second end, the valve body having an first end opening at the first end, a second end opening at the second end, and at least one side opening between the first end and the second end, the first end opening and the second end opening axially facing each other and in fluid communication with each other and with the side opening; the ball being axially movable inside the valve body and being releasably retained by a holding member at the first position between the side opening and the first end opening of the valve body;
connecting the valve body to a filter head of the filter so that the side opening is in fluid communication with an outlet opening of an outlet defined by the filter head;
allowing filtered fluid to flow through the side opening, through the outlet opening and into the outlet when a correct filter cartridge is installed, the first end opening of the valve body is sealed and the ball is retained at the first position by the holding member so that the side opening is in fluid communication with the outlet opening; and
not allowing fluid to flow into the outlet by moving the ball from the first position to a second position where the ball seals the outlet opening from the side opening when no filter cartridge is installed or an incorrect filter cartridge is installed.
